(19) United States
(12) Patent Application Publication
(10) Pub. No.: US 2005/0117570 A1
(43) Pub. Date: Jun. 2, 2005

(54) Wireless communication techniques

(76) Inventors: Zoran Cetusic, Avon, IN (US); Donald E. Brown, Indianapolis, IN (US); David Fuller, Noblesville, IN (US); Robert Harris, Indianapolis, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 11/028,165

(22) Filed: Jan. 3, 2005

Related U.S. Application Data
(62) Division of application No. 09/939,081, filed on Aug. 24, 2001.
(60) Provisional application No. 60/227,527, filed on Aug. 24, 2000.

(51) Int. Cl. H04L 12/66; H04J 3/12; H04Q 7/00

(52) U.S. Cl. 370/352; 370/329

(57) ABSTRACT

A novel system is presented for providing computer telephony services to remote, mobile users. In one form, a server communicates wirelessly with a remote, mobile, personal communication subsystem that includes a wireless voice communication device and a wireless data communication device, through a voice channel and a data channel, respectively. Telephonic communications passing between the wireless voice communication device and the server are controlled by commands and/or informed by communications through the wireless data communication device. The voice channel may carry incoming and/or outgoing calls distributed by an ACD, the calls being accompanied by information transmitted through the data channel that might traditionally have been presented in a “screen pop” or other informational display. In another form, users of the subsystems request and/or receive updates through the data channel regarding the availability status of one or more other users of the system.

### REFERENCE TO RELATED APPLICATION

Priority is claimed to co-pending U.S. Provisional Patent Application No. 60/227,527.

### BACKGROUND

The present invention relates to wireless communication techniques.

Today there are many different, commercially available devices that enable people to communicate with each other electronically. In addition to the ubiquitous telephone that has been around for decades, there now are cordless phones for the home, mobile phones for the car, handheld wireless phones which fit into a person's jacket pocket, pagers, local and wide area computer networks, and facsimile machines, to name just a few. U.S. Pat. No. 5,652,789 provides additional background concerning these types of devices and is hereby incorporated by reference.

This proliferation of devices and media present new challenges in devising techniques to communicate more efficiently and/or effectively. The present invention meets such challenges and has other benefits and advantages.

### BRIEF DESCRIPTION OF THE DRAWINGS

FIG. 1 is a partial schematic view of a communication system showing various aspects of a call center in detail.

FIG. 2 is a schematic view of the system of FIG. 1 including several personal communication subsystems.

### DETAILED DESCRIPTION OF SELECTED EMBODIMENTS

For the purpose of promoting an understanding of the principles of the invention, reference will now be made to the embodiments illustrated in the drawings and specific language will be used to describe the same and certain alternatives thereto. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Among the embodiments of the present invention is a system comprising a communication server and at least one personal communication subsystem. The personal communication subsystem includes one or more wireless communication devices, and wirelessly communicates with the server through at least a first channel and a second channel. The first channel provides for transmission of voice and the second channel provides for transmission of data and/or control signals (collectively and generically called “data signals” herein). The second channel can be used to send commands from the subsystem to direct handling of a telephone call carried by the first channel, including call initiation, receipt, transfer, recording, and/or conferencing. Alternatively or additionally, the second channel can be used to transmit data to at least one of the one or more wireless devices from the server. This data can include, as non-limiting examples: company directory information, voice mail status, availability status of system users, company account information accessible through the server, and the like.

Still another additional or alternative feature includes retrieving voice mail in response to commands over the second channel for playback over the first channel. Yet another additional or alternative form includes utilizing the subsystem to inquire into the status of other persons communicating through the server and to request notification and/or updates relating to the status—e.g., providing a “camping” function.

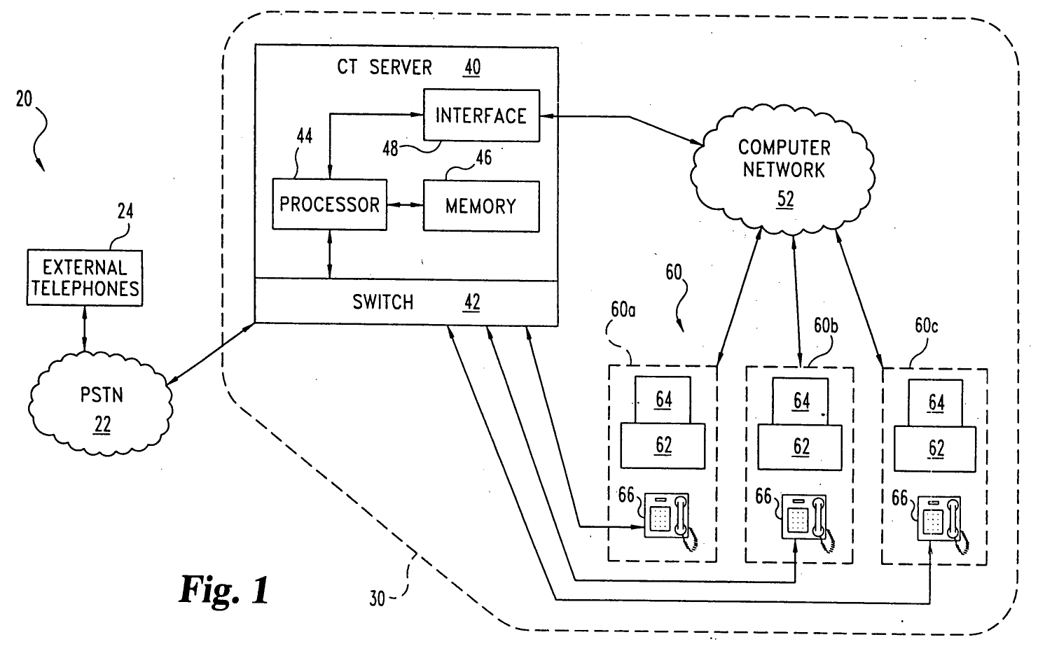

FIG. 1 schematically illustrates communication system 20 of one embodiment of the present invention. System 20 includes Public Switched Telephone Network (PSTN) 22 operatively coupled to a number of external telephones 24 and communication center 30. Communication center 30 includes communication/Computer Telephony (CT) server 40 with telecommunications switch 42 coupled to PSTN 22. Server 40 also includes processor 44, memory 46, and network interface 48. Network interface 48 is operatively coupled to computer network 52.

It should be understood that server 40 can include more than one processor or CPU and more than one type of memory, where memory 46 is representative of one or more types. Furthermore, it should be understood that while one server 40 is illustrated, more servers can be utilized in alternative embodiments. Processor 44 can be comprised of one or more components configured as a single unit. Alternatively, when of a multi-component form, processor 44 can have one or more components located remotely relative to the others. One or more components of processor 44 can be of the electronic variety defining digital circuitry, analog circuitry, or both. In one embodiment, processor 44 is of a conventional, integrated circuit microprocessor arrangement, such as one or more PENTIUM III or PENTIUM 4 processors supplied by INTEL Corporation. For this embodiment, switch 42 can be in the form of one or more telephone communication processing boards provided by DIALOGIC.

Memory 46 can each include one or more types of solid-state electronic memory, magnetic memory, or optical memory, just to name a few. By way of non-limiting example, memory 46 can include solid-state electronic Random Access Memory (RAM), Sequentially Accessible Memory (SAM) (such as the First-In, First-Out (FIFO) variety or the Last-In First-Out (LIFO) variety), Programmable Read Only Memory (PROM), Electrically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, memory 46 can be volatile, nonvolatile, or a hybrid combination of volatile and nonvolatile varieties.

Network 52 can be in the form of a Local Area Network (LAN), Wide Area Network (WAN) such as the Internet, or other network type as would occur to those skilled in the art. Also coupled to network 52 are a number of communication stations 60a, 60b, 60c (collectively designated workstations 60). Workstations 60 each include workstation computer 62 coupled to display 64. Although not shown to preserve clarity, each workstation 60 can also include one or more operator input devices such as a keyboard, mouse, track ball, light pen, and/or microphone, to name just a few representative examples. Also, besides display 64, one or more other output devices can be included such as loudspeaker(s) and/or a printer.

Each workstation 60 further includes a telephone unit 66 as schematically illustrated in FIG. 1. Telephone units 66 can be in the form of a handset, headset, or other arrangement as would occur to those skilled in the art. Alternatively or additionally, voice communication can be integrated into the corresponding workstation computer 62. Workstations 60 can be arranged identically to one another or may differ from one to the next as would occur to those skilled in the art. In one common arrangement, one workstation is designated for a supervisor that has different capabilities than those of other workstations. Furthermore, it should be understood that more or fewer workstations may be utilized than those illustrated.

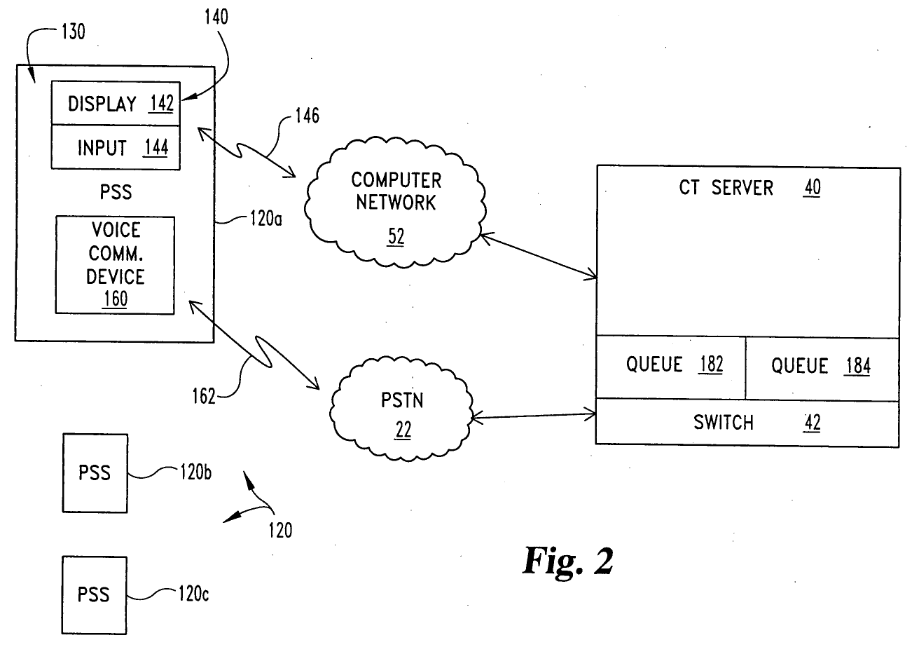

Referring additionally to FIG. 2, several mobile/personal communication subsystems 120a, 120b, 120c are illustrated (collectively designated personal communication subsystems (PSSs) 120). It should be understood that more or fewer subsystems 120 can be utilized than the number illustrated in FIG. 2. Referring specifically to subsystem 120a, further details representative of each of subsystems 120 are shown. Subsystem 120a includes a mobile set 130 of wireless communication devices including wireless personal digital assistant (PDA) 140 and wireless voice communication device 160.

PDA 140 includes a visual display 142 and input device 144. Input device 144 is typically in the form of a keyboard, keypad, or stylus and PDA 140 can be any of a number of different types of wireless personal communication devices operable to transmit and receive data signals, including, but not limited to: PALM PILOTS, two-way pagers, Remote Electronic Mail Systems (REMS) and the like. PDA 140 wirelessly communicates over wireless communication network 146. In turn, network 146 is operable to communicate with computer network 52 either directly or via one or more intermediate networks such as the Internet.

Display 142 is arranged to display status information and/or other data provided by server 40 to PDA 140 via networks 52 and 146. Input device 144 is arranged to selectively transmit data signals over networks 52 and 146 to server 40. These data signals may be interpreted by server 40 as commands or instructions, or as information to be stored in memory 46.

Voice communication device 160 is typically in the form of a Personal Communication Services (PCS) or cellular telephone, but can be any type of mobile/wireless device for voice communication. Device 160 wirelessly communicates over wireless voice network 162, and is optionally coupled to communicate through PSTN 22. In turn, PSTN 22 is communicatively coupled to switch 42 of server 40. While PDA 140 and device 160 are illustrated as separate devices in set 130, in one alternative embodiment PDA 140 and device 160 are integrally combined in a single unit. In still other arrangements, set 130 can include more than two wireless communication devices. In yet other embodiments, one or more of PDA 140 and device 160 may alternatively or additionally be hardwired to server 40. In one alternative, PDA 140 can be mated with any type of telephone, such as a pay-phone or standard hardwired phone, to provide a remote communication set.

In operation, each of workstations 60 and subsystems 120 can be logged-in to server 40 as a communication user of system 20; where users at workstations 60 are local to server 40 and users of systems 120 are remote and mobile. In the case of workstations 60, the server login procedure is performed with a respective workstation computer 62 over network 52. For a representative subsystem 120, login can be by way of the respective PDA 140 via networks 146 and 52. After logging in, telephone calls to and from units 66 and devices 160 can be routed through switch 42 under the control of server 40. Also, server 40 can be programmed to respond to various telephone call handling commands sent with computers 62 and PDAs 140; where computers 62 and PDAs 140 each function as clients of server 40. For example, telephone call initiation, receipt, transfer, recording, and conferencing can be controlled by such commands for telephone units 66 of workstations 60 and devices 160 of subsystems 120.

Furthermore, workstations 60 or PDAs 140 can be used to retrieve voice mail for playback over the respective telephone unit 66 or device 160, or to retrieve an email or fax for presentation on display 64 or 142, respectively. Also, a company directory, a user's voice mail status (for example, whether the user has messages waiting, or the numbers of new and old messages available), availability status of one or more other users, company account information, and the like, accessible with server 40, can be retrieved for presentation on display 64 or 142 in response to one more corresponding commands from the computer 62 or PDA 140.

Indeed, server 40 can be programmed to provide one or more various call routing/handling services to both local and remote/mobile users. For example, under the control of communication server 40, switch 42 can be configured to operate in the form of a Private Branch Exchange (PBX), predictive dialer, Interactive Voice Response (IVR) device, Automatic Call Distributor (ACD), a combination of these, or another switching configuration as would occur to those skilled in the art.

Alternatively or additionally, system 20 can be arranged to provide for the coordination, conversion, and distribution of a number of other forms of communication, such as faxes, web chats, and the like for access by workstations 60 and subsystems 120. Furthermore, system 20 can be arranged to convert between various communication forms such as the conversion of a pixel-based communication, such as a fax, into character form, such as an email. Alternatively or additionally, system 20 can be arranged to convert a character-based document, such as an email, into voice form, such as a voice mail. Furthermore, business/customer data associated with various communications may be stored in memory 46 and selectively accessed by one or more workstation computers 62 of workstations 60 or PDAs 140 of subsystems 120. This data can be presented with a respective display 64 for workstations 60 or display 142 for PDAs 140. Likewise, web chats and call backs can be initiated via server 40 with computer 62 or PDA 140.

In some of these embodiments, system 20 recognizes contact information in or relating to a communication and enables the user of work stations 60 and subsystems 120 to establish communications with those contacts in a convenient fashion. For example, names of individuals or companies might be recognized from a facsimile, voice mail message, electronic mail message, or web chat text using techniques that would occur to one skilled in the art. Alternatively or additionally, the contact might be identified using information from the context of the message, such as an electronic mail message envelope or facsimile information line. The contact information may then be used with a public or private directory to obtain information necessary to contact the individual or company. The user of workstation 60 or subsystem 120 is preferably enabled, via a user interface, to request that a communication be initiated with such a contact through a single gesture in the user interface. Such an embodiment might, for example, enable a user to view a facsimile image and, simply by pressing a stylus to a touch-sensitive display, be connected (via voice communication device 160) with the sender of the facsimile.

Alternatively or additionally, server 40 can be configured to provide a “camping” feature. This feature permits one user to receive the status on display 64 or 142 of another user by appropriate command from computer 62 or PDA 140, respectively. This status could indicate if the other user is on the phone, at home, unavailable to outside calls, only available to inside calls, on vacation, in a meeting and the like. Further, one can “camp” on the other user by requesting notification when the status changes from one type to another type and/or by automatically receiving updated status information from time to time on the respective display 64 or 142. In other embodiments, one can request and obtain notification when the other user's status changes from one type to a specific other type, such as the “unavailable to outside calls” status. These notifications may be in the form of an audio or visual signal through PDA 140; a ring, ring pattern, or call through voice communication device 160; or other notification means as would occur to one skilled in the art. Any of these techniques could also be used to provide one with notification of a change in availability status for a group of users, such as (by way of non-limiting example) an ACD split, computer system help desk team, or a department.

It should be understood that, in this illustrated embodiment, subsystems 120 each provide a remote, personal, and mobile version of a workstation 60. Accordingly, the services provided by server 40 can be readily extended to a mobile user including PBX, IVR, and ACD functions. Indeed, system 20 can be used to provide a mobile, remote agent member that is one of a pool of agents allocated for receiving queued, inbound customer calls automatically distributed by any of a number of standard ACD processes. Alternatively or additionally, outbound calls can be automatically distributed to mobile, remote agents via subsystem 120. In either case, information regarding person with whom the agent is connected can be transmitted to the wireless data communication device 140 and displayed for the agent to facilitate servicing of the call.

Furthermore, it is envisioned that system 20 can be arranged to service a large number of subsystems 120 with or without workstations 60. As such, it provides a way for a company to interconnect its employees and utilize a wide variety of services not normally available to remote, mobile users. Moreover, this arrangement facilitates customization of services in keeping with the particular needs of the company. Alternatively or additionally, services can be provided with system 20 through subscriptions for individual users or different groups of users (such as companies or other organizations). Further, based on the user's identity, particular type of subscription, and/or membership in a particular group of users, access to data with server 40 and or available server operations can differ.

As diagrammatically illustrated in FIG. 2, server 40 includes two process thread queues to manage communication routing between workstations 60, subsystems 120, and one or more external callers via PSTN 22 or data sources via computer network 52. A first thread queue 182 handles receipt of incoming service requests, including network operations and other input/output activities. A second thread queue 183 manages threads that handle those requests and generate responses thereto, such as database operations, setup of triggers, notifications, and the like. It has been found that this arrangement facilitates the handling of a surprisingly large number of users. In many situations, typical threads in the first queue take longer than typical threads in the second queue, or are limited in speed by input/output operations.

In another embodiment, a technique of the present invention includes routing a telephone call to a remote location with a communication server, and controlling the call through communications between the server and a wireless device at the remote location. The call control can include transferring the call or arranging call conferencing through the server with a local workstation, another remote user, and/or an outside party. The wireless device can be a PDA and the call can be received at the remote location with a wireless voice communication device like a PCS or cellular telephone.

In a further embodiment, an ACD includes one or more personal communication subsystems that are remote and mobile relative to a communication server for the ACD. The server selectively routes calls from the PSTN through a private switch to a wireless telephone at each of the one or more subsystems for handling by remote/mobile agents. These agents each interact with the server through a wireless data communication device that can be integral with or separate from the wireless telephone.

In still another embodiment, a system includes a communication server coupled to a number of remote and mobile personal communication subsystems that are in wireless communication with the server. The server is arranged to selectively route voice communication to each of the subsystems and respond to data signals from the subsystems. In one form, the voice and data signals are through separate channels. In one variation of this form, the subsystems each include a wireless telephone or other type of voice communication device coupled to one wireless network for voice communications and a PDA coupled to another wireless network for data/control communications.

Yet another embodiment includes providing a communication system with a server and one or more remote and mobile subsystems. The server is operable to provide the status of one user to another user and, upon request, provide notification and/or updates relating to the status. Communications between the server and subsystems can include wireless transmissions to and/or from one or more devices comprising a subsystem.

A further embodiment of the present invention links one or more remote and mobile personal communication subsystems to a private communication server controlled by a company. The server is operable to provide information specific to the company, such as a company directory or company account information, in response to a requesting one of the subsystems. The subsystems can include means for vocal communication, and for communicating data and/or control signal information over wireless networks. Furthermore, the server can include both a private telephone switch coupled to the PSTN and a connection to a publicly accessible computer network like the Internet. For this arrangement, each subsystem can include a PDA for communicating with the server via the computer network and a wireless voice communication device such as a wireless telephone for communicating through the private telephone switch of the server.

All publications, patents, and patent applications cited in this specification are herein incorporated by reference as if each individual publication, patent, or patent application were specifically and individually indicated to be incorporated by reference and set forth in its entirety herein. While the invention has been illustrated and described in detail in the drawings and foregoing description, the same is to be considered as illustrative and not restrictive in character, it being understood that only selected embodiments have been shown and described and that all changes, equivalents, and modifications that come within the spirit of the inventions, embodiments, and forms described herein are desired to be protected.

1. A system, comprising:
a private communication server maintaining availability information regarding a plurality of users;
a plurality of personal communication subsystems, each associated with a user in the plurality of users, and each in wireless communication with said server; and
a data channel between said server and a first one of said plurality of subsystems, the first one of said subsystems being associated with a first user;
wherein said server is configured
to communicate at least a portion of the availability information through said data channel to at least a first subsystem, and
to respond to command signals carried from the first subsystem to said server by said data channel.

2. The system of claim 1, wherein said server is further configured to communicate updates to the at least a portion of the availability information through said data channel at predetermined intervals.

3. The system of claim 1, wherein:
said command signals comprise a request for an update to the at least a portion of the availability information when the availability information changes for a second user in the plurality of users, and
said server is further configured to provide the requested update in response to said request.

4. The system of claim 3, wherein said server provides the update through said data channel.

5. The system of claim 4, wherein:
the request specifies a particular new status, and
the change is an update of the second user to the particular new status.

6. The system of claim 3, wherein said server provides the updates by establishing a voice connection between the first user and the second user through the voice channel when the availability information changes for a second user changes to a predetermined state.

7. The system of claim 6, wherein:
said first subsystem has a user interface; and
said request is generated by said first system in response to a single action in the user interface by the first user.

8. The system of claim 1, wherein the association between the first subsystem and the first user is made using a log-in procedure.

9. The system of claim 8, wherein the portion of the availability information accessible to the first subsystem is limited on the basis of the association with the first user.

10. The system of claim 9, wherein
the first user is associated with one or more organizations, and
the limiting allows access by the first user to availability information relating only to users in the plurality of users who are also associated with at least one of the one or more organizations.

11. The system of claim 8, wherein:
the first subsystem comprises a personal digital assistant; and
the log-in procedure is performed using the personal digital assistant.

12. The system of claim 1, wherein:
each subsystem in said plurality of subsystems comprises:
a wireless voice communication device coupled to a first wireless network; and
a wireless data communication device coupled to a second wireless network; and
said data channel connects said server and said wireless data communication device through the second wireless network.

13. The system of claim 1, further comprising a plurality of workstations in wired communication with said server, each associated with one or more users in the plurality of users.

14-35. (canceled)

36. A communication system, comprising:
a server; and
a plurality of remote and mobile subsystems in communication with said server, said plurality of subsystems comprising
a first subsystem associated with a first user; and
a second subsystem associated with a second user;
wherein said server is operable to
provide availability status information regarding the second user to the first user;
accept a command signal from the first subsystem requesting updated status information regarding the second user; and
provide the updated status information.

37. The system of claim 36, wherein
said first subsystem comprises a wireless data communication device, and
the status information and updated status information are communicated from said server to said wireless data communication device.

38-39. (canceled)
